(19) United States
(12) Patent Application Publication
(10) Pub. No.: US 2013/0074163 A1
(43) Pub. Date: Mar. 21, 2013

(54) USER EQUIPMENT AND CONTROL METHOD THEREFOR

(71) Applicants: Shingo Murakami, Kanagawa (JP); Toshikane Oda, Tokyo (JP)

(72) Inventors: Shingo Murakami, Kanagawa (JP); Toshikane Oda, Tokyo (JP)

(73) Assignee: Telefonaktiebolaget L M Ericsson (publ), Stockholm (SE)

(21) Appl. No.: 13/700,462

(22) PCT Filed: Jun. 10, 2010
(86) PCT No.: PCT/JP2010/060252

§ 371 Date: Nov. 28, 2012

(51) Int. Cl. G06F 21/00

(52) U.S. Cl. 726/4

(57) ABSTRACT

There is provided a User Equipment comprising: a content obtaining unit that obtains a content item that is not reproducible without permission data for enabling reproduction of the content item; a receiving unit that receives the permission data; a detecting unit that detects that the permission data indicates that a subscriber of a predetermined network operator is entitled to reproduce the content item using the permission data; a key obtaining unit that obtains key data from a module managing subscription information for the predetermined network operator by sending, to the module, information representing the predetermined network operator and information representing an authentication server for determining validity of the key data; a determining unit that determines whether or not the key data is valid by communicating with the authentication server; and a reproducing unit that reproduces the content item using the permission data if it is determined that the key data is valid.

### TECHNICAL FIELD

The present invention generally relates to a User Equipment and a control method for the User Equipment.

### BACKGROUND

Open Mobile Alliance (OMA) released an approved enabler of Digital Rights Management Version 2 (OMA DRM 2.0) on Mar. 3, 2006. The OMA DRM 2.0 Enabler Release defines the protocols, messages and mechanisms necessary to implement the DRM system in the mobile environment.

In OMA DRM 2.0, as in other similar DRM systems, protected content is delivered to user devices and the content can be consumed along with particular Rights Objects (ROs). The ROs can be acquired through a network in a secure manner. The acquisition mechanism is specified as the Rights Object Acquisition Protocol (ROAP) and it involves two important OMA DRM 2.0 entities: “Device” and “Rights Issuer”.

According to Section 15.1 of OMA DRM Specification Version 2.0, OMA DRM 2.0 supports binding an RO to an International Mobile Subscriber Identity (IMSI). By binding an RO to an IMSI, a content provider may offer an RO that is valid when a user maintains a subscription to a specific network operator. Because an RO is bound to an IMSI that is unique to a specific subscription between a user and a network operator, the content provider may, for example, partner with the network operator in order to make a special offer (e.g., selling content at a discount) to subscribers of that network operator.

However, schemes whereby an RO is bound to an IMSI involve several problems, as described below.

First, in order for a DRM agent to reproduce content by using an RO bound to an IMSI, the DRM agent must trust the IMSI obtained from a SIM platform (e.g., a Universal Integrated Circuit Card (UICC)) that hosts a SIM. This means that the DRM agent must trust the SIM platform.

The DRM agent may be able to trust the SIM platform if the DRM agent and the SIM platform are implemented in a managed way when shipped from a factory because the network operator assumes that the software contained in mobile terminals before shipping are all trusted. However, this assumption cannot be maintained if a user dynamically changes or adds DRM agents by downloading DRM agent software to a mobile terminal (for example, users may download and install new video player software that implements a DRM agent).

In this case, in order for the new DRM agent to trust the existing SIM platform, some additional complex procedure is required. For example, the DRM agent can trust the SIM platform if the DRM agent authenticates the SIM platform using a digital signature and certificate of the SIM platform as well as a certificate revocation check. However, this authentication procedure is costly in terms of implementation because it requires a global certification program and PKI infrastructure for managing trust model for SIM platforms.

Another problem is that a user must disclose their IMSI to a content provider that generates an RO bound to the IMSI; however, in view of privacy concerns, revealing an IMSI to third parties such as content providers is often undesirable. In fact, for instance, content providers of NTT DoCoMo's i-mode service are forbidden from obtaining the IMSI of a user.

Yet another problem exists in that a user cannot reproduce content that requires, for reproduction, an RO bound to their IMSI when they replace their current mobile terminal SIM with a new SIM, even if the new SIM involves a subscription with the same network operator. This may happen, for example, when a user uses one SIM for business and another SIM for personal use. If users are able to download SIM in a software form into mobile terminals in accordance with the technology specified in 3GPP TR 33.812, this problem will become even more marked because users can then easily change their SIMs.

For example, assume a case wherein a user who has subscription to a given operator purchases content that requires, for reproduction, an RO bound to their current IMSI for reproduction. Then, the user terminates the subscription and re-subscribes to the same operator, but the operator assigns a different IMSI to the user. In this case, the user can no longer reproduce the purchased content even though the user still has a subscription with the same operator. This situation is disadvantageous not only for the user but also for the operator because the operator cannot provide the user with convenient and attractive services.

### SUMMARY

The present invention is intended to address the above-described problem, and it is a feature thereof to introduce a technology by which permission data such as an RO, which is required for reproduction of content, is bound to a network operator and a user can reproduce the content using the RO as long as the user has a subscription to the same network operator. It should be noted that the “network operator” in this context may be a group of a plurality of network operators.

According to the first aspect of the present invention, there is provided a User Equipment comprising:

a content obtaining unit that obtains a content item that is not reproducible without permission data for enabling reproduction of the content item;

a receiving unit that receives the permission data;

a detecting unit that detects that the permission data indicates that a subscriber of a predetermined network operator is entitled to reproduce the content item using the permission data;

a key obtaining unit that obtains key data from a module managing subscription information for the predetermined network operator by sending, to the module, information representing the predetermined network operator and information representing an authentication server for determining validity of the key data;

a determining unit that determines whether or not the key data is valid by communicating with the authentication server; and

a reproducing unit that reproduces the content item using the permission data if it is determined that the key data is valid.

According to the second aspect of the present invention, there is provided a method for controlling a User Equipment, the method comprising:

a content obtaining step of obtaining a content item that is not reproducible without permission data for enabling reproduction of the content item;

a receiving step of receiving the permission data;

a detecting step of detecting that the permission data indicates that a subscriber of a predetermined network operator is entitled to reproduce the content item using the permission data;

a key obtaining step of obtaining key data from a module managing subscription information for the predetermined network operator by sending, to the module, information representing the predetermined network operator and information representing an authentication server for determining validity of the key data;

a determining step of determining whether or not the key data is valid by communicating with the authentication server; and

a reproducing step of reproducing the content item using the permission data if it is determined that the key data is valid.

The main advantage of the present invention is that a user can have permission data such as an RO that is bound to a network operator to which the user is subscribing instead of user-specific information such as an IMSI.

Further features of the present invention will become apparent from the following description of exemplary embodiments with reference to the attached drawings, in which like reference characters designate the same or similar parts throughout the figures thereof.

### BRIEF DESCRIPTION OF DRAWINGS

FIG. 1 illustrates a block diagram of a User Equipment 100 according to an embodiment of the present invention;

FIG. 2 is a sequence diagram illustrating a content reproducing procedure according to the embodiment of the present invention; and

FIG. 3 shows an example of an RO bound to a predetermined operator.

### DETAILED DESCRIPTION

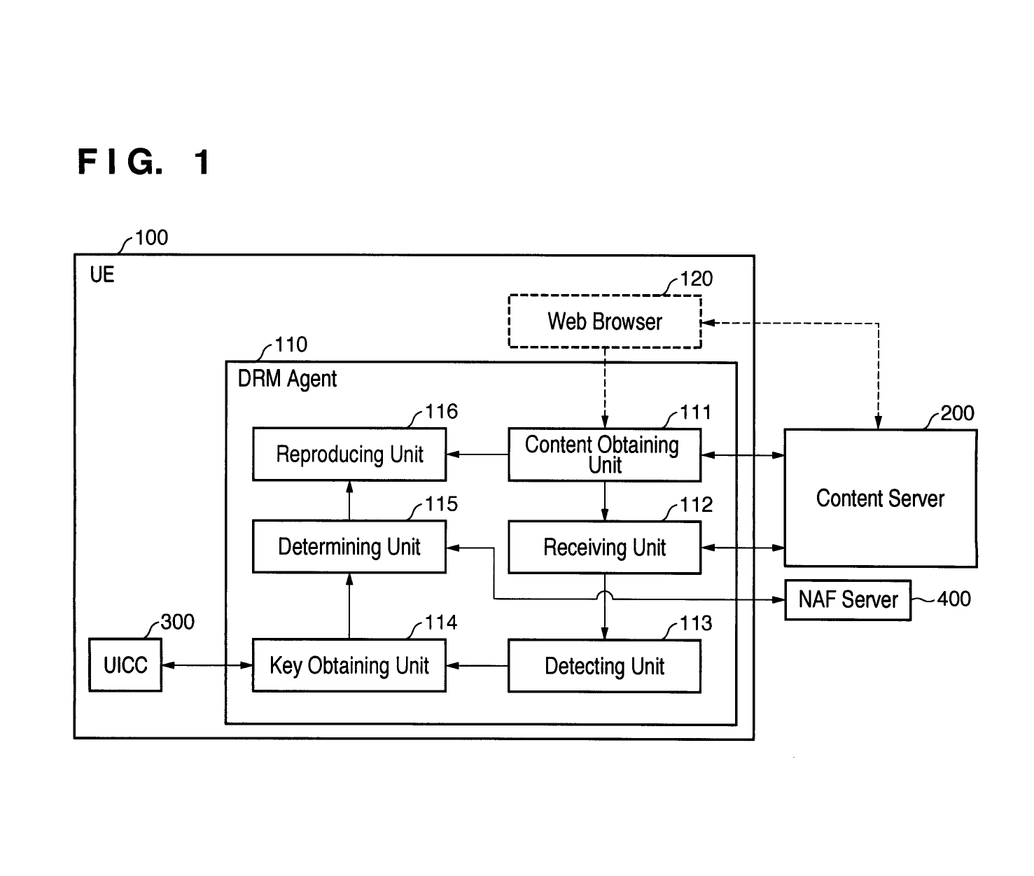

FIG. 1 illustrates a block diagram of a User Equipment (UE) 100 according to an embodiment of the present invention. The UE 100 may be implemented in various electronic devices such as a mobile phone, a personal computer, or the like.

The UE 100 comprises a digital rights management (DRM) agent 110. The DRM agent 110 comprises a content obtaining unit 111, a receiving unit 112, a detecting unit 113, a key obtaining unit 114, a determining unit 115, and a reproducing unit 116. It should be noted that the functionality of each block in the DRM agent 110 may be implemented using dedicated hardware, using software executed by a processor (not shown), or a combination thereof.

The content obtaining unit 111 is configured to function as a content browser, and obtains content items (e.g., an audio file, a video file, etc.) from a content server 200. Alternatively, the content obtaining unit 111 may not function as a content browser. In this case, as described by dashed lines, the UE 100 comprises a Web browser 120 that functions as the content browser and obtains content items from the content server 200, and the content obtaining unit obtains the content items from the Web browser 120.

The key obtaining unit 114 is configured to access a Universal Integrated Circuit Card (UICC) 300. The UICC 300 comprises a module such as a Universal Subscriber Identity Module (USIM) or an IMS Subscriber Identity Module (ISIM) that manages subscription information for a network operator. Although the UICC 300 is included in the UE 100 in the present embodiment, the UICC 300 may be located outside the UE 100 as long as the key obtaining unit 114 may access the UICC 300.

The determining unit 115 is configured to perform authentication procedure with a Network Application Function (NAF) server 400 by means of, for example, a Generic Bootstrapping Architecture (GBA), as specified in 3GPP TS 33.220 V7.3.0 (2006-03).

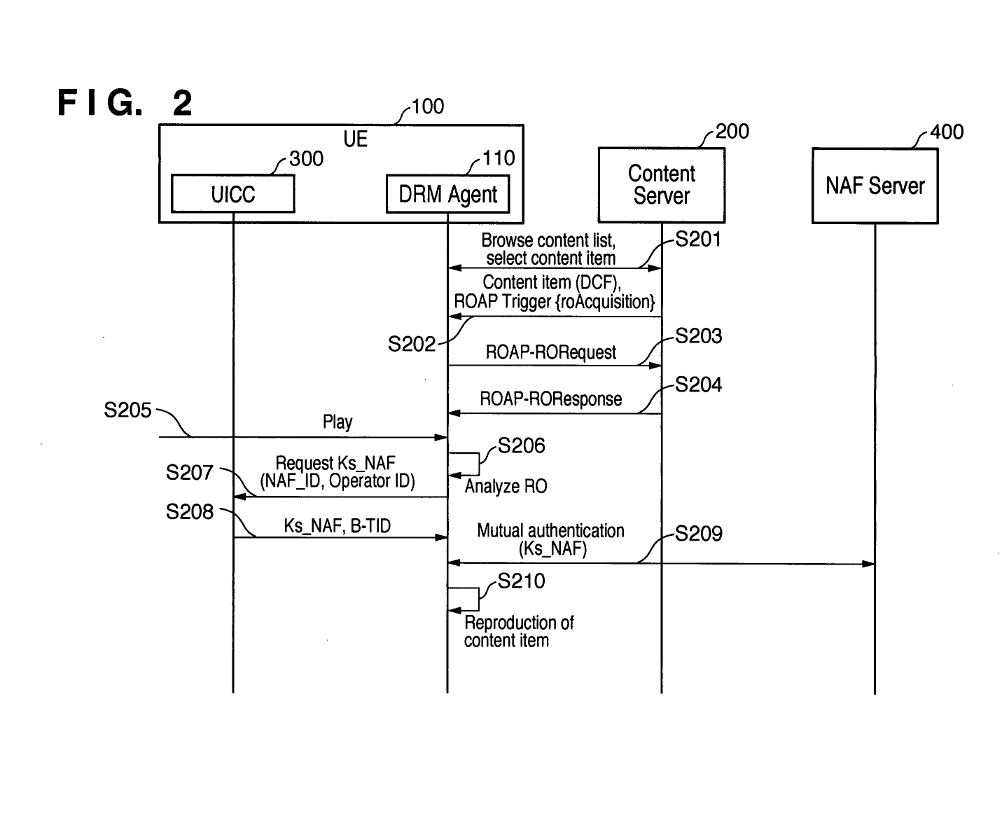

The detailed operations of each block in the DRM agent 110 will be described later with reference to the sequence diagrams of FIG. 2.

FIG. 2 is a sequence diagram illustrating a content reproducing procedure according to the embodiment of the present invention.

In step S201, a user of the UE 100 browses a content list of the content server 200 using the content obtaining unit 111 functioning as a content browser, and selects a content item that the user wishes to reproduce. In this step, the content obtaining unit 111 may implicitly or explicitly notify the content server 200 of a network operator to which the user is subscribing.

In step S202, the content obtaining unit 111 obtains the selected content item from the content server 200. The obtained content item is in DRM content format (DCF), and therefore, it is not reproducible without an associated RO. The content obtaining unit 111 also obtains, from the content server 200, a Rights Object Acquisition Protocol (ROAP) Trigger for acquisition of the RO. In the present embodiment, it is assumed that, based on an implicit or explicit request from the user of the UE 100, the content server 200 decides to provide the user with an RO that is bound to the network operator of the user. Accordingly, the ROAP Trigger includes information for acquisition of such an RO.

In an alternative embodiment, the Web browser 120 may perform the above processing of steps S201 and S202 on behalf of the content obtaining unit 111, and the content obtaining unit 111 may obtain the content item and the ROAP Trigger from the Web browser 120.

In step S203, the receiving unit 112 sends a ROAP RORequest to a Rights Issuer (RI) specified in the ROAP Trigger. In the present embodiment, it is assumed that the content server 200 acts as the RI. Moreover, it is assumed that ROAP Device Registration has already been performed.

In step S204, the receiving unit 112 receives, from the content server 200, a ROAP ROResponse which includes the RO for enabling reproduction of the content item obtained in step S202.

In step S205, the user instructs the DRM agent 110 to reproduce the content item via, for example, a play button (not shown) of the user interface of the DRM agent 110.

In step S206, the detecting unit 113 analyzes the RO received in step S204, and detects that the RO is bound to a predetermined network operator. In other words, the detecting unit 113 detects that the RO indicates that a subscriber of a predetermined network operator is entitled to reproduce the content item using the RO.

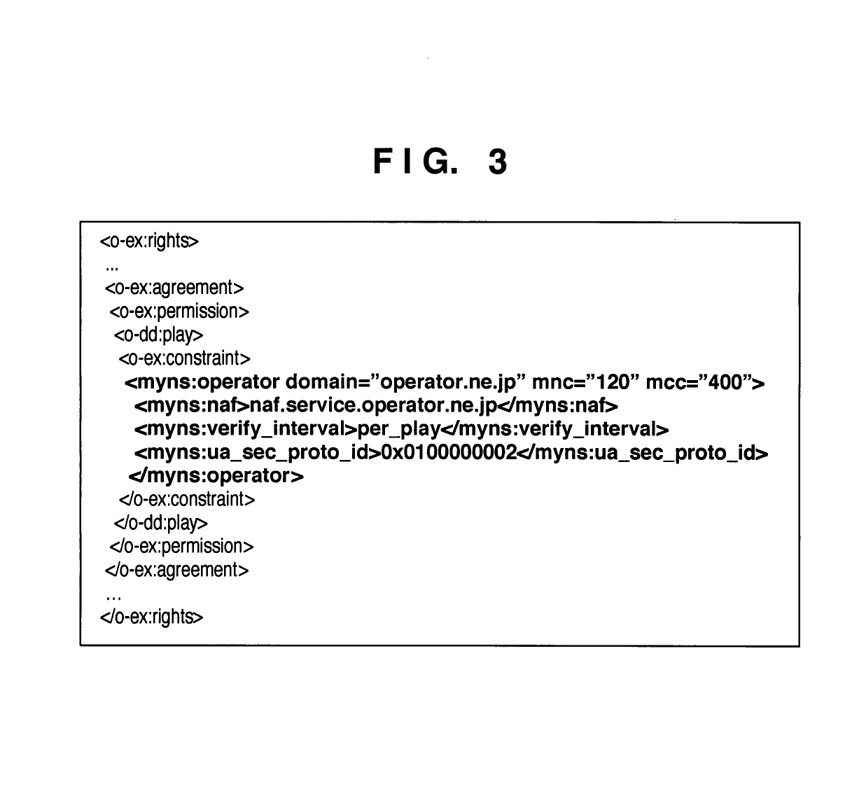

FIG. 3 shows an example of an RO bound to a predetermined operator. In FIG. 3, lines starting with “<myns:” relate to binding to a given network operator. Specifically, the element “operator” indicates the network operator to which the RO is bound. The network operator is represented by an operator domain name (“operator.ne.jp”) and MNC+MCC (“120.400”).

The element “naf” indicates the Fully Qualified Domain Name (FQDN) of a NAF server (e.g., the NAF server 400) that acts as an authentication server. In the example shown in FIG. 3, the NAF server is run by the network operator, but the content provider may run the NAF server. In an alternative embodiment, the RO does not include the element “naf”, and the DRM agent 110 obtains the information regarding the NAF server in a different way. For example, the key obtaining unit 114 may retrieve the information regarding the NAF from software implementing the DRM agent 110. In this case, the manufacturer of the DRM agent 110 may embed the information regarding the NAF in the program code of the software implementing the DRM agent 110.

The element “verify_interval” indicates how often the constraint regarding a network operator should be verified. For example, if this element specifies “per_play”, the DRM agent 110 performs the verification of the constraint per play.

The element “ua_sec_proto_id” indicates what protocol should be used to perform mutual authentication with the NAF server specified by the element “naf”. The syntax is defined in Annex B3 of 3GPP TS 33.220. In the example of FIG. 3, the specified protocol is HTTP Digest Authentication.

It should be noted that the RO may be bound to a plurality of network operators. In this case, the RO includes a plurality of elements “operator”, each of which includes sub-elements “naf”, “verify_interval”, and “ua_sec_proto_id”.

Referring back to FIG. 2, in step S207, the key obtaining unit 114 requests key data (Ks_NAF) from the UICC 300. In this step, the key obtaining unit 114 sends NAF_ID (concatenation of NAF FQDN and Ua Security Protocol Identity) and the operator identity (domain name and MNC+MCC) to the UICC 300.

In step S208, the UICC 300 searches for an available ISIM or USIM that manages subscription information for the network operator specified by the operator identity received in step S207. If an available ISIM or USIM is not found, the UICC 300 returns an error to the key obtaining unit 114, and the key obtaining unit 114 concludes that the user of the UE 100 is not a subscriber of the network operator to which the RO is bound. Accordingly, the DRM agent 110 does not reproduce the content item. If the available ISIM or USIM is found, the ISIM or USIM derives a Ks_NAF based on the NAF_ID received in step S207, and the key obtaining unit 114 receives the derived Ks_NAF together with B-TID.

In step S209, the determining unit 115 determines whether or not the Ks_NAF is valid. Specifically, the determining unit 115 communicates with the NAF server 400 and performs mutual authentication using the Ks_NAF. If the mutual authentication succeeds, the determining unit 115 determines that the Ks_NAF is valid and the user of the UE 100 is a subscriber of the network operator to which the RO is bound.

In step S210, the reproducing unit 116 reproduces the content item using the RO if it is determined that the Ks_NAF is valid.

As described above, according to the embodiment of the present invention, permission data such as an RO, which is required for reproduction of a content item, is bound to a network operator and a user can reproduce the content item using the RO as long as the user has a subscription to the same network operator. However, if the user terminates their subscription to a specific network operator after the user obtains an RO (see step S204 of FIG. 2), the mutual authentication (see step S209 of FIG. 2) fails, and therefore, the user, who is no longer a subscriber of the specific network operator, cannot reproduce the content item. Nevertheless, if the user re-subscribes to the specific network operator, the user can reproduce the content item again even if user-specific information such as an IMSI is changed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A User Equipment comprising:
a content obtaining unit that obtains a content item that is not reproducible without permission data for enabling reproduction of the content item;
a receiving unit that receives the permission data;
a detecting unit that detects that the permission data indicates that a subscriber of a predetermined network operator is entitled to reproduce the content item using the permission data;
a key obtaining unit that obtains key data from a module managing subscription information for the predetermined network operator by sending, to the module, information representing the predetermined network operator and information representing an authentication server for determining validity of the key data;
a determining unit that determines whether or not the key data is valid by communicating with the authentication server; and
a reproducing unit that reproduces the content item using the permission data if it is determined that the key data is valid.

2. The User Equipment according to claim 1, wherein:
the key obtaining unit retrieves the information representing the authentication server from the permission data.

3. The User Equipment according to claim 1, wherein:
the content obtaining unit obtains the content item from a content server; and
the content obtaining unit notifies the content server that the module manages the subscription information for the predetermined network operator.

4. The User Equipment according to claim 1, wherein
the module is an IMS Subscriber Identity Module (ISIM) or a Universal Subscriber Identity Module (USIM);
the authentication server is a Network Application Function (NAF) server; and
the key data is Ks_NAF.

5. A method for controlling a User Equipment, the method comprising:
a content obtaining step of obtaining a content item that is not reproducible without permission data for enabling reproduction of the content item;
a receiving step of receiving the permission data;
a detecting step of detecting that the permission data indicates that a subscriber of a predetermined network operator is entitled to reproduce the content item using the permission data;
a key obtaining step of obtaining key data from a module managing subscription information for the predetermined network operator by sending, to the module, information representing the predetermined network operator and information representing an authentication server for determining validity of the key data;
a determining step of determining whether or not the key data is valid by communicating with the authentication server; and
a reproducing step of reproducing the content item using the permission data if it is determined that the key data is valid.

6. The method according to claim 5, wherein the key obtaining step comprises:
retrieving the information representing the authentication server from the permission data.

7. The method according to claim 5, wherein the content obtaining step comprises:
obtaining the content item from a content server; and
notifying the content server that the module manages the subscription information for the predetermined network operator.

8. The method according to claim 5, wherein:
the method performed by the module is performed by an IMS Subscriber Identity Module (ISIM) or a Universal Subscriber Identity Module (USIM);
the method performed by the authentication server is performed by a Network Application Function (NAF) server; and
the key data is Ks_NAF.
